(19) United States
(12) Patent Application Publication
(10) Pub. No.: US 2022/0353647 A1
(43) Pub. Date: Nov. 3, 2022

(54) Method for identifying wireless communication device user

(71) Applicants: Igor Sergeevich LEKONTSEV, Perm (RU); Aleksei Leonidovich KALINICHENKO, Domodedovo (RU)

(72) Inventors: Igor Sergeevich LEKONTSEV, Perm (RU); Aleksei Leonidovich KALINICHENKO, Domodedovo (RU)

(21) Appl. No.: 17/764,278

(22) PCT Filed: Sep. 29, 2020
(86) PCT No.: PCT/RU2020/050252

§ 371 Date: Mar. 28, 2022

(30) Foreign Application Priority Data
Sep. 30, 2019 (RU) 2019130806

(51) Int. Cl. H04W 4/18; H04W 8/18; H04W 4/14

(52) U.S. Cl. CPC H04W 4/185; H04W 8/18; H04W 4/14

(57) ABSTRACT

There are proposed a method for identifying users of a wireless communication device and a system for implementation thereof. The method includes the steps of receiving a MAC address of the device by a subsystem of the system and creating instructions that, when executed, cause the device to launch a subprogram in an application, A user then starts working with the subprogram. A subprogram user identifier or reference thereto is provided in the user's identification subsystem. A reference to the device MAC address associated with the subprogram user identifier is passed to the user identification subsystem, and the user identification subsystem saves the reference to the user identifier and the reference to the device MAC address associated therewith. The proposed method and device allow for simplifying the procedure for identifying the user.

### CROSS-REFERENCE TO RELATED APPLICATIONS

This application is a U.S. national stage application of an international application PCT/RU2020/050252 filed on 29 Sep. 2020, published as WO2021066682, which international application claims priority of a Russian Federation patent application RU2019130806 filed on 30 Sep. 2019.

### FIELD OF THE INVENTION

This invention pertains to wireless communication systems (in particular, to radio communication), more specifically, the invention pertains to systems and methods of identifying users of wireless communication devices.

### BACKGROUND OF THE INVENTION

There is a known method of collecting data on the wireless communication device user, described in WO2018044198 (A1) dated 8 Mar. 2018. The method is characterised in that it comprises steps during which at least one server is provided, wherein the server is connected with at least one machine-readable medium comprising at least a part of the database, and the server is configured so that it is capable of transmitting data to the wireless communication devices; the wireless communication device identifier is received; the identifier of the communication session with the wireless communication device is created; the said session identifier is associated with the said wireless communication device identifier; the said session identifier and the said device identifier associated therewith are saved in the database; the session identifier is transmitted to the wireless communication device to be recorded in the data storage of the wireless communication device; at least one session identifier and at least one application user identifier are received from the wireless communication device; at least one application user identifier and at least one session identifier are saved in the database; at least one said application user identifier and at least one said session identifier are associated with the device identifier.

The known method also provides for creating a database that contains information on the user's device network connections via wireless access points (such as Wi-Fi) associated with the unique device identifier, such as the MAC address identifier. To that end, the method makes use of the device browser and its storage (such as the cookies). This means that in order to implement this method, it is necessary to secure the permission for launching the browser and editing files in the browser local storage. This constrains the use of the known method, since the possibility of its implementation depends on the availability of these permissions.

There is a known method of designating a wireless communication device, described in WO2015108447 (A1) dated 23 Jul. 2015. The method comprises steps during which a network packet containing a device identifier is received; the device identifier is determined; it is checked whether the device identifier is contained in a database; whenever the device identifier is not contained in the database, an installed application which, by means of the device, sends an activation request to the system, is launched; the application identifier is determined; the application identifier associated with the device identifier is saved in the database. Meanwhile, the application identifier could contain the address to send push notifications. The known method provides for creating a database containing the information on the users and their connections to wireless access points to send push notifications to users in a targeted manner.

The drawback of the known method is that it requires an application pre-installed on the user's device, which makes successful referencing of the user contingent on the installation of the application.

The known system was accepted as the closest equivalent (prototype) of the present invention.

### SUMMARY OF THE INVENTION

The developers of the present invention were faced with a task of expanding the capabilities for referencing and identifying wireless communication devices in local areas.

In the first aspect of this invention the task was addressed by creating a method of identification of a wireless communication device comprising the steps during which:

the subprogram is provided;

the device is provided which is designed so that it is capable of connecting to a wireless local network and containing a pre-installed customer part of the application, which is configured so that it is capable of executing the subprogram in the application;

the user identification subsystem is provided;

the wireless communication subsystem is provided, a possibility to connect the device to a wireless local network via a wireless communication subsystem using a radio channel is provided;

the wireless communication subsystem receives the device's MAC address;

the instructions forcing the device to launch the subprogram in the application are generated;

a possibility to initiate execution of instructions is provided;

whenever execution of instructions is initiated on the device, the subprogram is launched in the application in accordance with the instructions received;

a possibility to start working with the subprogram is provided for the user;

whenever the user starts the subprogram, the subprogram user identifier or a designation thereof is provided in the user identification subsystem;

a designation of the device's MAC address associated with the subprogram user identifier is transmitted to the user identification subsystem;

the user identification subsystem saves the designation of the user identifier and the associated designation of the device's MAC address.

In the second aspect of the invention the task was addressed by creating a wireless communication device identification system comprising:

the wireless communication subsystem;

the user identification subsystem;

the subprogram designed so that it is capable of launching in the application as the device executes the instructions to launch the subprogram in the application;

whereas, the wireless communication subsystem includes a wireless network access module and a server of communications provider; and is designed so that it is capable of connecting the device to a wireless local network with a possibility of obtaining the device's MAC address;

whereas, the system is designed so that it is capable of transmitting instructions for launching the subprogram in the application to the wireless communication device;

whereas, the user identification subsystem is designed so that it is capable of receiving designations of the user identifier from the application administrator; is capable of receiving designations of the wireless communication device's MAC address; and is capable of saving designations of the user identifier and the associated designation to the device's MAC address.

In the third aspect of this invention the task was addressed by creating a machine-readable medium containing machine-executable instructions that (as they are executed by the system for the sake of wireless communication device identification) the subprogram is provided;

the device is provided which is designed so that it is capable of connecting to a wireless local network and containing a pre-installed customer part of the application, which is configured so that it is capable of executing the subprogram in the application;

the user identification subsystem is provided;

the wireless communication subsystem is provided, a possibility to connect the device to a wireless local network via a wireless communication subsystem using a radio channel is provided;

the wireless communication subsystem receives the device's MAC address;

the instructions forcing the device to launch the subprogram in the application are generated;

a possibility to initiate execution of instructions is provided;

whenever execution of instructions is initiated on the device, the subprogram is launched in the application in accordance with the instructions received;

a possibility to start working with the subprogram is provided for the user;

whenever the user starts the subprogram, the subprogram user identifier or a designation thereof is provided in the user identification subsystem;

a designation of the device's MAC address associated with the subprogram user identifier is transmitted to the user identification subsystem;

the user identification subsystem saves the designation of the user identifier and the associated designation of the device's MAC address.

The technical result of the disclosed invention in all its aspects consists in a simplification of the user identification procedure. The simplification is due to the fact that the identification process does not require any dedicated software to be installed on the user's device.

### PREFERRED EMBODIMENTS OF THE INVENTION

For the embodiments of the disclosed invention in its first aspect, it is possible to use the wireless communication device identification system disclosed in the second aspect of this invention.

In accordance with the second aspect of this invention, the wireless communication device identification system contains a wireless network communication subsystem. It is possible to use a system of access to the global network or certain wireless local networks as a wireless network communication subsystem by connecting the user's device through a Wi-Fi channel as per any Wi-Fi standard.

The wireless network communication subsystem is supposed to enable the connection of the device to the network whenever the device is located in a certain local area. For the purpose of this application, local areas may be construed, inter alia, as the coverage areas of wireless local networks, operating as per such standards as, for instance, IEEE 802.11, IEEE 802.15.1, IEEE 802.15.4, or any other wireless networks based on IEEE 802.11 standard. This means that a local area may be determined by the coverage area of a single or multiple wireless network access modules that may be represented by access points, routing devices, repeaters, routers, or any other devices capable of ensuring wireless network access via a radio channel (Wi-Fi). In addition to the wireless network access module, the wireless communication subsystem may include a server of communications provider. A server of communications provider may be represented by either a certain central remote server and a certain computer or group of computers located locally and remotely and connected so as to enable data exchange with the wireless communication modules. The wireless communication subsystem is designed so that it is capable of connecting the device to a wireless local network. Availability of the communication module and relevant permissions makes it possible to connect the device to a wireless local network.

In accordance with this invention, the wireless communication subsystem is designed so that it is capable of transmitting instructions for launching the subprogram in the application to the wireless network access device. These instructions may be provided in the form of an html link, java script instructions, or any other form. It is possible to use any sequence of characters or signals that makes or lets the device launch the subprogram in the application when processed by the device after it had been sent thereto as instructions. The instructions for launching the subprogram in the application may be transmitted through any communication channel, including Wi-Fi, visual or visible light communication channel, or any radio channel capable of transmitting such instructions. Besides, such instructions may be transmitted by means of a text (short) message transmitted to the device using any known method.

The preferred embodiment of the invention provides for the instructions for launching the subprogram in the application in the form of a link containing a designation of the application and a designation of the subprogram. Meanwhile, the application shall be designed so that it is capable of processing links.

In accordance with this invention, the wireless communication subsystem is designed so that it is capable of receiving the wireless communication device's MAC address from the wireless communication device. The device MAC address is used for identification of the wireless communication device in the Wi-Fi network; furthermore, the MAC address is used for assignment of the IP address to the device. Therefore, whenever the wireless communication device is connected to a Wi-Fi network and starts interfacing with this network, the MAC address is supposed to be transmitted to the wireless network communication subsystem.

In accordance with this invention, the wireless communication subsystem is designed so that it is capable of receiving the identification link containing a designation of the subprogram user. When the device is connected to the network using a Wi-Fi connection, the links used to direct the device are transmitted by the system to the wireless network communication subsystem. The link may contain a designation of the subprogram user identifier either in the form of the identifier as such or in a hashed form.

For the purpose of this description the terms “designation of the subprogram user identifier” and “designation of the device's MAC address” are used. For the purpose of confidentiality or for other purposes, the transmission, processing, and/or storage of the very subprogram user identifier and the device's MAC address may be restricted along with their storage. Therefore, steps of the method may be executed using certain identifiers corresponding to the subprogram user identifier and the device's MAC address; these are the identifiers that are designated herein by such attributes as “designation of the subprogram user identifier” and “designation of the device's MAC address”. However, it is necessary to understand that wherever a designation of the subprogram user identifier is used, it is technically possible to use the very subprogram user identifier as well; and wherever a “designation of the device's MAC address” is used, it is technically possible to use the very device's MAC address as well. A designation of a certain value, for instance, may be this very value in a hashed form.

In accordance with this invention, the wireless communication subsystem is designed so that it is capable of transmitting a designation of the subprogram user identifier and a designation of the device's MAC address to the user identification subsystem. Transmission may be made possible by connecting the said subsystems to the Internet or by using a different telecommunications network for transmission purposes.

It is necessary to understand that the wireless communication subsystem and the user identification subsystem are separated herein for convenience only based primarily on the relevant combination of software and hardware facilities. However, there are certain embodiments where the said subsystems are implemented in a single device or a group of devices as part of the same combination of software and hardware facilities. In those embodiments, the instructions, MAC address, and/or certain identifier may be transmitted through the exchange thereof between different software and/or hardware modules.

In accordance with this invention, the user identification system includes the user identification subsystem. Whereas, the user identification subsystem is designed so that it is capable of receiving designations of the user identifier from the application administrator; is capable of receiving designations of the wireless communication device's MAC address; and is capable of saving designations of the user identifier and the associated designation to the device's MAC address. Any computer system that includes a computer, for instance, a server, may be used as the user identification subsystem. The user identification subsystem is designed so that it is capable of connecting to the network to ensure the transmission of data (including the device's MAC address or designation thereof, as well as the user identifier or designation thereof) between the wireless communication subsystem and the user identification subsystem. The user identification subsystem may include the subprogram administrator or be designed so that it is capable of performing administrator functions. Possibility to save the designation of the user identifier and the associated designation of the device's MAC address may be ensured due to the fact that the user identification is linked to a local or remote data medium, database, or any other storage that makes it possible to record the values associated with each other. The subprogram administrator may also be designed separately from the user identification subsystem in particular and from the user identification system as a whole. In this case, in embodiment of the invention it may serve as an intermediary during the data exchange between the application administrator and the parts of the system. In accordance with this invention, the method includes a step during which a possibility to connect the device to a wireless local network via a wireless communication subsystem using a radio channel is provided. This may be made possible by a channel to connect to a wireless local network available to the device. For this purpose the wireless communication subsystem may comprise a wireless network access module, for instance, a Wi-Fi router. Meanwhile, connection of the device to the local network may be contingent on the location of the device within the wireless network coverage area, i.e., within the local area.

Besides, the method in accordance with this invention includes a step where the wireless communication subsystem receives the device's MAC address. Preferably, this step is executed at the time, when the device is connected to the network or while connecting the device to the network. MAC address is the unique network identifier used for addressing purposes in the network. In practice, transmission of the MAC address to the wireless communication subsystem is the mandatory precondition for successful connection to a wireless local network, that is the capability of the wireless communication subsystem to receive the device's MAC address is a mandatory attribute for the subsystem that the device may connect via a Wi-Fi communication channel.

Under a certain embodiment of this invention, the method also contains a step providing for generation of instructions, execution of which force the device to launch the subprogram in the application. These instructions may be provided in the form of an html link, java script instructions, or any other form. The instructions for launching the subprogram in the application may be transmitted through any communication channel, including Wi-Fi, visual or visible light communication channel, or any radio channel capable of transmitting such instructions. The preferred embodiment of the invention provides for the instructions for launching the subprogram in the application in the form of a link containing a designation of the application and a designation of the subprogram. This link may be displayed either in the dialog window in the application or through any other data transmission channel or messaging method. The instructions may be generated by the wireless communication subsystem and transmitted thereby to the device via Wi-Fi or through any other communication channel. To execute the said step, the user identification system is designed so that it is capable of transmitting the instructions for launching the subprogram in the application to the wireless communication device. This possibility may be provided both in the wireless communication subsystem and in the user identification subsystem.

Meanwhile, the subprogram is designed so that it is capable of launching in the application as the device executes the instructions to launch the subprogram in the application. In the case of the embodiment of the invention, where the instructions are provided as a link to the subprogram, this possibility may be ensured by the fact that the subprogram is assigned with its own address (URI) in the application, and the application is capable of processing instructions in the form of such link.

In addition, the method includes a step during which a possibility to initiate the execution of instructions is provided. This step may provide for displaying the instructions on the screen of the device as a link in a dialog window, a button, or any other enabled or disabled visual element on the screen of the device. In certain embodiments of the invention, the method may include a step during which the execution of instructions by the device is initiated automatically. In certain embodiments of the invention, the method may include a step during which the user initiates the execution of instructions, for instance, by clicking on the link or any other enabled element.

In accordance with this invention, the method includes a step during which, whenever execution of instructions is initiated on the device, the subprogram is launched in the application in accordance with the instructions received. The launch of the subprogram in the application is ensured by the availability of the subprogram to the device in the application. In case of the embodiments of the invention, where the subprogram is designed as a chat bot, in order to launch the subprogram in the application, the application administrator provides the device and/or user with access to the subprogram in the application and enables the exchange of messages and/or commands between the subprogram administrator (chat bot, dialog or chat in a social medium) and the device in the chat; meanwhile, the subprogram administrator (chat bot, dialog or chat in a social medium) ensures the operation of the subprogram. In case of embodiments of the invention where the subprogram is designed as a group or community in a social medium, the application administrator provides the device and/or user with access to the subprogram in the application and to the resources required for the operation of the subprogram.

In case of certain embodiments of the invention, the subprogram may be launched in the application automatically by directing the device to the link that contains a designation of the application and a designation of the subprogram in the application (e.g., by using a deep link technology).

In addition, the method includes a step during which a possibility to start working with the subprogram is provided for the user. This possibility may be ensured by enabling the exchange of messages between the device and the subprogram administrator. In this case, the subprogram administrator receives the subprogram user identifier. In accordance with this invention, this procedure may be used to execute the step during which the subprogram user identifier is provided in the user identification subsystem whenever working with the subprogram is started. It may either take the form of the subprogram user identifier or be generated as a unique subprogram user identifier. In accordance with this invention, whenever the user starts working with the subprogram, the subprogram user identifier or a designation thereof is provided in the user identification subsystem. In different embodiments of the invention, the subprogram user identifier may be provided in the user identification subsystem through sending the subprogram user identifier by the subprogram administrator (unless the subprogram administrator forms part of the user identification subsystem), by the application administrator, or by the wireless communication subsystem. In certain embodiments of the invention, the subprogram administrator may form part of the user identification subsystem; hence, the subprogram user identifier may be provided in the user identification subsystem through transmission from the application administrator. The “subprogram administrator” attribute herein is construed as any combination of facilities (hardware and software facilities) controlling the subprogram operation that has an access to subprogram administration. Whenever a chat bot is used as the subprogram, the subprogram administrator contains and executes the instructions and algorithms used by the subprogram, in particular, sends messages to the user's device via the chat bot. Whenever a social media group is used as the subprogram, the subprogram administrator has an access to administer the group, engages with the users on behalf of the group and/or its administrators.

Besides, the method in accordance with this invention includes a step where a designation of the device's MAC address associated with the subprogram user identifier is transmitted to the user identification subsystem. Meanwhile, such transmission may take different forms in different embodiments of the invention disclosed below.

The method in accordance with this invention includes a step during which the user identification subsystem saves the designation of the user identifier and the associated designation of the device's MAC address. These data may be stored in a certain database to which the user identification subsystem can access, on a data medium that the user identification subsystem can access, or otherwise using any known method.

The attribute “associated” is construed as a certain association between values, for instance, between the MAC address and the subprogram user identifier, as well as between the designations thereof. This situation may be ensured by associating them in a database or otherwise using any method making it possible to establish that a group of identifiers is attributable to a single user or device (i.e., these identifiers are associated with each other). In this case it is obvious that a certain value and a designation thereof are attributable to a single user, i.e., they are associated with each other by default.

In the preferred embodiments of this invention, the instructions for launching the subprogram in the application are embedded in the subprogram link that contains the application reference and the application reference. Meanwhile, the application is designed so that it is capable of opening the resource using the subprogram launching link. In certain embodiments, the application may be designated as a browser, and the link may be created in a manner forcing the device to open the browser by default whenever the link is used. In this case, a social media group or chat bot in the browser version (web version) of the application containing a messenger may be used as a resource.

In the preferred embodiment of the invention, where the application is represented by an application designed so that it is capable of exchanging messages (as a messenger), and the subprogram is represented by a chat bot, the link may be represented by a URI link (deep link technology) and may contain a designation of the application and a designation of the chat bot. Whenever the application enables data transmission as part of the link, the link may contain supplementary data, in particular, a designation of the device's MAC address.

The capability of the application to open the resource located under the subprogram link may be ensured due to compatibility of the resource and the application on the one hand, and due to the capability of the application to process the links, in particular, the subprogram link, on the other hand.

In different embodiments of the invention, the method steps during which in the user identification subsystem, the subprogram user identifier is provided, and a designation of the device's MAC address associated with the subprogram user identifier is transmitted to the user identification subsystem, may be executed in different ways. Hereinafter, these embodiments are referred to as “Embodiment 1 of the invention” and “Embodiment 2 of the invention”. The choice of a certain embodiment may depend on the functional capabilities of the wireless communication device identification system and/or functional capabilities of the application.

### Embodiment 1 of the Invention

Embodiment 1 of this invention may be implemented on condition that the application is designed so that it is capable of processing the links containing a data unit, for instance, deep links. To that end, the application shall make it possible to transmit the content of the data unit under the link used to direct the user's device to the resource to the subprogram administrator.

In Embodiment 1 of the invention, the subprogram link is preferably generated by the wireless communication subsystem. That is, the wireless communication subsystem is designed so that it is capable of generating instructions for launching the subprogram in the application. Meanwhile, the subprogram link contains a designation of the device's MAC address. Thereafter, the link is transmitted to the device by any known method.

The device is directed to the resource in accordance with the subprogram link. The device may either be directed as a result of the user's actions or automatically. In a certain embodiment, the link is transmitted to the device and displayed in the dialog with the chat bot. The user directs the device by using the link. In this case, the application administrator receives the link, including the designation of the device's MAC address.

In the preferred embodiment, a chat bot is used as the subprogram. Once the subprogram is launched, the user is provided with a link or a button that initiates launching of the subprogram.

The capability of processing the links that contain a data unit implies that once the user initiates launching of the subprogram, the application administrator will transmit the content of the data unit under the link used to direct the device to the subprogram administrator. In terms of the data unit, the link in Embodiment 1 of the invention includes the user identifier or a designation thereof, the MAC address or a designation thereof. Thus, once the user initiates launching of the subprogram, the user identification subsystem will receive the device's MAC address and the subprogram user identifier. Meanwhile, in the embodiment where the user identification subsystem is designed so that it is capable of receiving designations of the subprogram user identifier and associated designations of the wireless communication device's MAC address from the application administrator, the user identification subsystem may either include the subprogram administrator or be associated therewith. In the latter case, the user identification subsystem will receive the data mentioned above from the application administrator via the subprogram administrator.

The subprogram user identifier may either be generated separately as a unique subprogram user identifier or represent a subprogram user identifier, being unique in relation to all application users. For the embodiment of this invention, the key is the fact that this specific user's identifier is unique in relation to the identifiers of the subprogram user's array.

In case of embodiments where a chat bot is used as the subprogram, launching of the subprogram should be construed as launching of the dialog window to engage with the chat bot; and launching of the subprogram should be construed as the action initiated by the user, whereby the chat bot receives the subprogram user identifier, and the user is provided with an opportunity to engage with the chat bot. In addition, launching may be initiated by enabling the application window with the launched subprogram, for example, to be displayed on the screen device.

Thus, Embodiment 1 of the invention envisions that the user identification subsystem receives the subprogram user identifier and the device identifier. The user identification subsystem saves the designation of the user identifier and the associated device identifier, e.g., the designation of the device's MAC address.

### Embodiment 2 of the Invention

Embodiment 2 of the invention may be used whenever the application is not capable for processing the links containing a data unit, such as deep links. In this case, it is impossible to transmit data to the subprogram administrator by creating a link to the resource for the content of the data unit.

The wireless communication subsystem is designed so that it is capable of generating instructions for launching the subprogram in the application. In case of the embodiment that provides for designing instructions as a link, instructions are generated by sending a certain data unit containing this link to the device. In this case, the link may be generated in advance and stored in the user identification system. In this embodiment of the invention it may be kept intact and generated by transmitting instructions to the device. It is obvious that in case of embodiments of the invention where the link is static and contains no data units, it may be generated prior to executing at least a part of the steps under this method, and yet the link is made available on the device by means of transmission from the wireless communication subsystem or user identification subsystem.

In case of Embodiment 2 of the invention, the method includes a step where the user identification subsystem receives the subprogram user identifier once the subprogram is started.

In case of embodiments of the invention where the subprogram is a chat bot, the subprogram may be started after the user clicks on the start button or on the link in the chat bot dialog window. In this case, the subprogram administrator receives the user identifier from the application administrator that may serve either as a unique subprogram user identifier or as a certain other identifier, for instance, generated as the subprogram user identifier, being unique among all subprogram users. In case of embodiments of the invention where the subprogram is a community or a similar suitable subprogram in a social medium, the subprogram administrator may receive the identifier either from the very user or from the application administrator, for example, as a link to the user profile, user login, or any other user identifier that is unique at least in relation to the multitude of users of the social medium or users of another subprogram.

Besides, the method includes a step during which the identification link that contains a designation of the subprogram user identifier is generated. This designation of the subprogram user identifier may be represented by the very identifier or any other associated identifier, for instance, a hashed value of the user. The content of the designation of the user identifier in the link may be implemented by means of a link containing a data unit, for example, a deep link. The identification link in the preferred embodiment of the invention is generated by the subprogram administrator upon receipt of the subprogram user identifier; however, there are certain embodiments of the invention where the identification link is generated by the application administrator.

Besides, the method in accordance with Embodiment 2 of the invention contains a step during which the generated identification link is transmitted to the device. In the preferred embodiment of the invention, the link is transmitted via the chat bot or social medium dialog window, but there are certain embodiments of the invention where the identification link is transmitted by other means, in particular, by text message, e-mail, push notification, etc.

Besides, the method in accordance with Embodiment 2 of the invention includes a step during which a possibility to direct the device using the identification link, which may be implemented by displaying an enabled link or button in the chat bot dialog window or in any other place, and clicking on the link or button will direct the device using the relevant link, is provided. Besides, there are certain embodiments that make it possible to direct the device using the identification link automatically.

Besides, the method in accordance with Embodiment 2 of the invention includes a step where the wireless communication subsystem receives the identification link whenever the device is directed using the identification link; concurrently, this will involve the execution of the step where the wireless communication subsystem receives the device MAC address associated with the subprogram user identifier. Whenever the device is directed using the identification link, it is possible to receive such identification link thanks to the fact that the network is accessed through connection to a wireless local network (Wi-Fi) ensured by the wireless communication subsystem, and the wireless communication subsystem knows the device's MAC address directed using this link, which makes it possible to associate the MAC address or designation thereof with the content of the identification link (i.e., the designation of the subprogram user identifier) unambiguously.

Besides, the method in accordance with Embodiment 2 of the invention includes a step during which the wireless communication subsystem transmits a designation of the subprogram user identifier and the associated designation of the device's MAC address to the user identification subsystem. This information may be transmitted by Internet, any other local network, or through any other data transmission channel, within the framework of this invention.

Besides, the method in accordance with Embodiment 2 of the invention includes a step during which the user identification subsystem saves the designation of the user identifier and the associated designation of the device's MAC address. It is preferable to save the designation of the user identifier and the associated designation of the device's MAC address in the database or otherwise. The data medium used to save information may form part of the very user identification subsystem or of a certain remote data medium that the user identification subsystem can access, or of any distributed database.

The systems and devices in accordance with this invention usually comprise a variety of machine-readable media. Besides, the invention in accordance with the third aspect represents a machine-readable medium containing machine-executable instructions; when executed by the system to identify a wireless communication device, they force the system to execute the steps of the wireless communication device identification method. Meanwhile, it is necessary to understand that such medium may also be represented by a group of tangible media, and the parts of instructions corresponding to individual steps may be stored on a group of machine-readable media.

A machine-readable medium may be represented by any appropriate medium that the system or device may access; moreover, this may be either a volatile medium or a nonvolatile medium, either a fixed medium or a removable medium. By way of illustration and not limitation: a machine-readable medium may contain a computer-based data storage medium and a communication medium. The computer-based data storage medium includes both a volatile medium and a nonvolatile medium, a removable medium and a fixed medium based on any method or any technology used for storage of such information, as machine-readable instructions, data structures, software modules, or other data. The computer-based data storage medium includes, without being limited to, RAM, ROM, EEPROM, flash memory, or any other memory technology, CD-ROM, DVD, or any other optical disk storage devices, magnetic cassettes, magnetic tapes, magnetic disk storage device, or any other magnetic storage devices, or any other medium that may be used for retaining of the required information and that the system or device can access. The communication medium normally embodies machine-readable instructions, data structures, software modules, or other data in a modulated data signal, such as the carrier signal or any other carrier and includes any information delivery medium. The term “modulated data signal” means a signal, a single or multiple properties of which are set or changed so as to encrypt the information in this signal. By way of illustration and not limitation: a communication medium includes a hardwire medium, such as the wired network or direct hardwired connection, and a wireless medium, such as the acoustic, radiofrequency, infra-red, and any other wireless medium. Besides, the list of machine-readable media should include combinations of any media mentioned above.

The drives and the associated computer storage media referred to above ensure the storage of machine-readable instructions, data structures, software modules, and other data required to operate the systems in accordance with this invention, in particular, to execute the methods in accordance with this invention.

This invention has been described in detail with a reference to the preferred embodiments thereof; however, it may obviously be implemented in diverse modifications within the framework of the protection scope determined by the claims appended hereto.

1. A method for identification of a wireless communication device having a MAC address and capable of connecting to a wireless local network and containing a pre-installed customer part of an application;
said method comprising the steps of
providing a subprogram; capable of being executed in the application;
providing a user identification subsystem;
providing a wireless communication subsystem;
providing a radio channel and enabling the device for connecting to the wireless local network via the wireless communication subsystem using the radio channel;
receiving said MAC address of the device by the wireless communication subsystem;
generating instructions capable of prompting the device to launch the subprogram in the application;
enabling initiating execution of the instructions;
upon initiating execution of the instructions on the device, launching the subprogram in the application in accordance with the instructions;
enabling a user to start working with the subprogram;
upon starting working with the subprogram, providing a subprogram user identifier or a designation of the subprogram user identifier in the user identification subsystem;
transmitting of the device's MAC address or a designation of the device's MAC address associated with the subprogram user identifier by the wireless communication subsystem to the user identification subsystem;
saving the designation of the user identifier and the associated designation of the MAC address by the user identification subsystem.

2. The method according to claim 1, wherein the instructions for launching the subprogram in the application are embedded in a subprogram link that contains an application reference and a subprogram reference; and the application is capable of opening a resource using the subprogram link.

3. The method according to claim 2, wherein the subprogram link contains the designation of the MAC address; and the designation of the subprogram user identifier and the associated designation of the MAC address are transmitted to the user identification subsystem by an application administrator.

4. The method according to claim 1, wherein the instructions for launching the subprogram in the application are embedded in the subprogram link.

5. The method according to claim 4, wherein the subprogram link is a short link.

6. The method according to claim 1, further including the steps of:
receiving the subprogram user identifier by the user identification subsystem upon starting working with the subprogram;
generating an identification link that contains a designation of the subprogram user identifier;
transmitting the identification link to the device;
enabling directing the device using the identification link;
receiving the identification link by the wireless communication subsystem upon directing the device using the identification link; concurrently executing the step where the wireless communication subsystem receives the MAC address of said device associated with the subprogram user identifier;
transmitting the designation of the subprogram user identifier and the associated designation of the MAC address of said device by the wireless communication subsystem to the user identification subsystem;
saving the designation of the user identifier and the associated designation of the MAC address of said device by the user identification subsystem.

7. The method as per according to claim 1, wherein characterised in that the application further includes an instant messaging system; and the subprogram is implemented in the form of a chat bot.

8. A wireless communication device identification system for a wireless communication device having a MAC address and capable of connecting to a wireless local network and containing a pre-installed customer part of an application; said wireless communication device identification system comprising:
a wireless communication subsystem;
a user identification subsystem;
a subprogram designed so that it is capable of launching in the application as the device executes instructions to launch the subprogram in the application; wherein:
the wireless communication subsystem further includes a wireless network access module and a server of communications provider, and is capable of connecting the device to the wireless local network and obtaining the MAC address of the device;
the wireless communication device identification system is capable of transmitting the instructions for launching the subprogram in the application to the wireless communication device;
the user identification subsystem is capable of: receiving the subprogram user identifier or a designation of a subprogram user identifier from an application administrator, receiving the MAC address of said device or a designation of the MAC address of said device; and of saving the subprogram user identifier or the designation of the subprogram user identifier and the associated the MAC address of said device or designation of the MAC address of said device.

9. The wireless communication device identification system according to claim 8 wherein the wireless communication subsystem is capable of generating instructions for launching the subprogram in the application.

10. The wireless communication device identification system according to claim 9, wherein:
the instructions for launching the subprogram in the application are embedded in a subprogram link that contains an application reference and a subprogram reference; and
the application is capable of opening a resource associated with the subprogram link.

11. The wireless communication device identification system according to claim 10, wherein the subprogram link contains a designation of the MAC address of said device; and
the user identification subsystem is capable of receiving the user identifier or a designation of the user identifier and the designation of the MAC address of said device from a subprogram administrator.

12. The wireless communication device identification system according to claim 8 wherein:
the wireless communication device identification system is capable of generating an identification link containing the subprogram user identifier or a designation of the subprogram user identifier is capable of transmitting an identification link to the device;
the wireless communication subsystem is capable of transmitting the identification link containing the subprogram user identifier or a designation of the subprogram user identifier to the user identification subsystem and capable of transmitting a designation of the MAC address of said device associated with the designation of the subprogram user identifier to the user identification subsystem.

13. A non-transitory machine-readable medium containing machine-executable instructions capable of being executed by an identification system configured for identification of a wireless communication device having a MAC address and capable of connecting to a wireless local network; said wireless communication device contains a pre-installed customer part of an application; and said application is configured to execute a subprogram;
wherein said instructions instruct the identification system to perform the following steps:
providing a subprogram capable of being executed in the application;
providing a user identification subsystem;
providing a wireless communication subsystem;
providing a radio channel and enabling the device for connecting to the wireless local network via the wireless communication subsystem using the radio channel;
receiving said MAC address of the device by the wireless communication subsystem;
generating instructions capable of prompting the device to launch the subprogram in the application;
enabling initiating execution of the instructions;
upon initiating execution of the instructions on the device, launching the subprogram in the application in accordance with the instructions;
enabling a user to start working with the subprogram;
upon starting working with the subprogram, providing a subprogram user identifier or a designation of the subprogram user identifier in the user identification subsystem;
transmitting of the device's MAC address or a designation of the device's MAC address associated with the subprogram user identifier by the wireless communication subsystem to the user identification subsystem;
saving the designation of the user identifier and the associated designation of the MAC address by the user identification subsystem.

14. The method according to claim 2, further including the steps of:
receiving the subprogram user identifier by the user identification subsystem upon starting working with the subprogram;
generating an identification link that contains a designation of the subprogram user identifier;
transmitting the identification link to the device;
enabling directing the device using the identification link;
receiving the identification link by the wireless communication subsystem upon directing the device using the identification link; concurrently executing the step where the wireless communication subsystem receives the MAC address of said device associated with the subprogram user identifier;
transmitting the designation of the subprogram user identifier and the associated designation of the MAC address of said device by the wireless communication subsystem to the user identification subsystem;
saving the designation of the user identifier and the associated designation of the MAC address of said device by the user identification subsystem.
